(19) United States
(12) Patent Application Publication
(10) Pub. No.: US 2020/0001821 A1
(43) Pub. Date: Jan. 2, 2020

(54) RESCUE RESTRAINT

(71) Applicants: Robert F. Wallace, Fort Myers, FL (US); Brian Chapman, Avon, IN (US)

(72) Inventors: Robert F. Wallace, Fort Myers, FL (US); Brian Chapman, Avon, IN (US)

(21) Appl. No.: 16/567,971

(22) Filed: Sep. 11, 2019

Related U.S. Application Data
(63) Continuation-in-part of application No. 16/412,056, filed on May 14, 2019.
(60) Provisional application No. 62/671,218, filed on May 14, 2018.

(51) Int. Cl. B60R 22/185; B60R 22/30

(52) U.S. Cl. CPC B60R 22/185; A61G 3/00; B60R 22/30

(57) ABSTRACT

A restraint system, in the form of a belt, can be worn about a rescue worker that may be positioned, for example, in a back of an ambulance. The belt may have a retractable lanyard mechanism, or a fixed length strap, on a back or side position thereof with a connector that may attached to a connection point within the ambulance. The lanyard may be designed to permit controlled movement of the worker about the rear of the ambulance, however, should sudden movement of the worker occur, the lanyard may lock and fix its position to help prevent the worker from being thrown about the ambulance during a sudden stop, accident, or the like.

### BACKGROUND OF THE INVENTION

### 1. Field of the Invention

One or more embodiments of the invention relates generally to safety devices. More particularly, the invention relates to a restraint system for emergency workers in locations such as in the back of an ambulance, where conventional safety belts prove insufficient.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Persons assisting a patient in the back of an ambulance, such as rescue workers, emergency medical technicians, paramedics, or the like, often has to move about for patient care and needs to be mobile and not attached to a seat with a conventional safety belt. In many situations, these people in the back of ambulances are not aware of the vehicle movement or its need for sudden stops or impending accidents. Thus, these people may be violently thrown about the back of an ambulance without any warning due to sudden stops, accidents, or the like. This could endanger the life not only of the rescue worker, but also the patient.

In view of the foregoing, there is a need for a restraint system for a rescue worker that helps secure the worker in the event of sudden vehicle movement, while allowing the worker to move about the patient without being restrained to a seat therein.

### SUMMARY OF THE INVENTION

Embodiments of the present invention provide a rescue restraint comprising a belt configured to be worn about a user; an extension piece extending from the belt; a first connector disposed on an end of the extension piece; and a second connector operable to be disposed in an emergency vehicle, the second connector mating with the first connector to secure the user within the emergency vehicle.

In some embodiments, one or more latches are configured to open and close a loop formed by the belt.

In some embodiments, a size adjustment feature permits a length of the belt to vary.

In some embodiments, the extension piece is a line, the line extending from a lanyard attached to the belt. In some embodiments, the first connector is a hook disposed at the end of the line.

In some embodiments, the extension piece is a strap extending generally orthogonally form the belt. In some embodiments, the first connector is an eye formed at an end of the strap and the second connector is a vehicle hook operable to be secured inside the emergency vehicle, wherein the hook retractable extends from a vehicle lanyard operable to be secured inside the emergency vehicle.

Embodiments of the present invention further provide a method of securing a person in an emergency vehicle comprising positioning a belt about a user; and attaching a first connector at a distal end of an extension piece, extending from the belt, to a second connector disposed in the emergency vehicle.

In some embodiments, the method further includes opening a loop formed by the belt with one of one or more latches disposed along a length of the belt.

In some embodiments, the method further includes adjusting a size of the belt via a size adjustment feature disposed along a length of the belt.

In some embodiments, the method further includes extending the first connector from a lanyard, the lanyard permitting a predetermined length of line to extend therefrom, the first connector disposed on an end of the line. In some embodiments, the method further includes restricting extending of the line from the lanyard when a velocity of the line exiting the lanyard exceeds a predetermined speed.

In some embodiments, the extension piece has a fixed length.

In some embodiments, an eye is disposed at the end of the extension piece, wherein the second connector attaches to the eye.

In some embodiments, the second connector is extendably attached to a vehicle lanyard mounted in the emergency vehicle.

In some embodiments, the second connector is removably attached to a rail of the emergency vehicle.

In some embodiments, the emergency vehicle is an ambulance.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a top view of a restraint belt according to an exemplary embodiment of the present invention;

FIG. 2 is a side view of a restraint belt according to another exemplary embodiment of the present invention; and

FIG. 3 is a side view of a restraint belt according to another exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a restraint system in the form of a belt that can be worn about a rescue worker that may be positioned, for example, in a back of an ambulance. The belt may have a retractable lanyard mechanism on a back or side position thereof with a connector that may attached to a connection point within the ambulance. The lanyard may be designed to permit controlled movement of the worker about the rear of the ambulance, however, should sudden movement of the worker occur, the lanyard may lock and fix its position to help prevent the worker from being thrown about the ambulance during a sudden stop, accident, or the like.

The belt may be an adjustable belt configured to be worn about the chest of the user, typically under their arms. The belt may have a buckle mechanism, often positioned at the front of the belt, to permit the user to easily don and doff the rescue restraint. A strap and connector may extend out of a mechanism located at the side or rear of the belt. The connector may be configured to attach to a mating connector inside the ambulance. The mechanism, as discussed above, may be a retracting mechanism that automatically retracts the strap therein and permits the strap to be extended therefrom. Should sudden retraction be noted, the mechanism may fix the length of the strap or may prevent any further amount of the strap to extend therefrom, thereby preventing uncontrolled movement of the user about the back of the ambulance.

The mating connector within the ambulance may be a connector at a ceiling of the ambulance, on a grab bar of the ambulance, or the like. Typically, the mating connector is positioned at a location above the user but may also be locations alongside the user.

In some embodiments, the mating connector may removably attach and be capable of being repositioned within the vehicle. For example, the mating connector may be a strap that removably attaches to various positions on grab bars within the ambulance.

While the above describes the belt having a buckle in the front, various mechanisms may be used to secure the belt to the wearer. For example, in place of the buckle, a hook and loop fastener may be used to secure the belt to the user. Typically, it is desirable to permit easy removal of the belt should sudden movement lock the lanyard mechanism and the user desires to quickly move about before the mechanism resets.

In some embodiments, the retraction mechanism and locking mechanism may be part of the mating connector attached inside the ambulance instead of being positioned on the belt. For example, a strap and connector may be retractably extended from a grab bar within the ambulance. The connector may attach at a side or rear of the belt to secure the user. While the location of the retraction/locking mechanism is different, in this embodiment, the function of the rescue restraint is exactly the same as that described above.

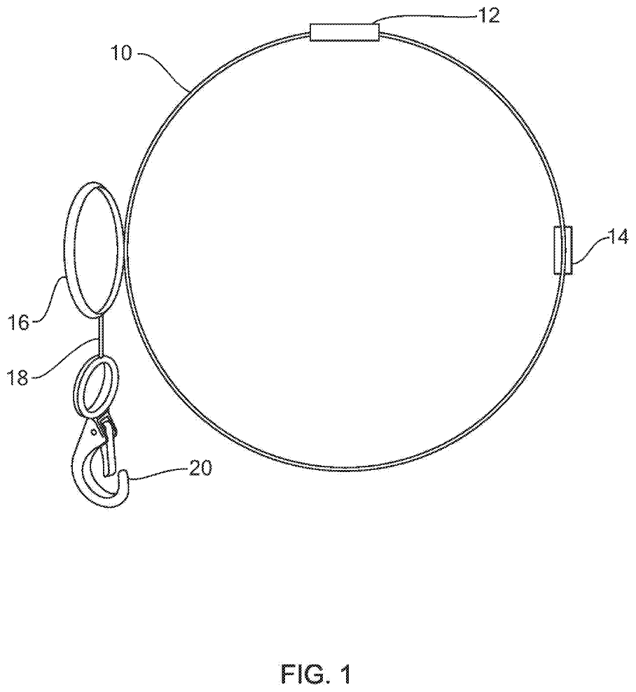

Reference is now made to various exemplary embodiments as described with reference to the Figures. Referring now to FIG. 1, a restraint belt 10 can include one or more latches 12 to permit the belt 10 to open and close. The latches 12 can take various forms as are known in the art. For example, the latches 12 may be a buckle latch, a pin latch, a click latch, a hook and loop fastener, one or more buttons, and the like. Typically, the latches 12 may be of the type that may stay firmly attached but can be used to easily don and doff the belt 10.

The belt 10 can include one or more size adjustment members 14 disposed along the loop formed by the belt 10. The size adjustment members 14 may be used to adjust the size of the loop formed by the belt 10. Various types of size adjustment members 14 may be used, as may be known in the art. For example, the size adjustment members 14 may be a pull-to-tighten with a lift-to-release mechanism, as are used in various devices, such as firefighting air tank straps, backpacks and the like. Other size adjustment members 14 can include hole-and-pin mechanisms, hook and loop members and the like. Typically, the size adjustment members 14 may be of the type that can maintain its size selection while being easy to tighten and release.

The belt 10 can include an attachment piece extending therefrom. This attachment piece may be a lanyard mechanism 16, as shown in FIG. 1, that allows a line 18 to extend and retract therefrom. The lanyard mechanism 16 may include a braking mechanism that prevents extension of the line 18 when the line 18 is extended at a rate over a predetermined minimum. Such mechanism can be similar to that used in a safety restraint of an automobile, for example. In some embodiments, a manual locking feature may be provided to fix an amount of line 18 that extends from the lanyard. Such a mechanism may be similar to, for example, a retractable pet leash mechanism that permits a fixed leash length to extend from the retracting reel.

In some embodiments, the line 18 may be elastic and permit extension thereof. Such an elastic line, similar to a bungee, may be useful to permit movement even if the lanyard mechanism 16 locks the length of the line 18. Further, such an elastic line can provide shock absorption should a rescue worker be restrained and the line 18 is stopped from further extending from the lanyard mechanism 16. The elastic line can also help keep the line 18 out of the way by permitting a shorter portion of the line to be used, where the user can stretch the line as needed to gain access within the vehicle, for example. Some or all of the line 18 may be formed from an elastic material.

A hook 20, or other similar removable attachment feature, may be disposed at a terminus of the line 18. The hook 20 may be used to attach the line 18 to a fixed member of a rescue vehicle, such as an ambulance. The hook 20 can attach, for example, to a fixed eye or rail disposed on a side wall or ceiling of the ambulance.

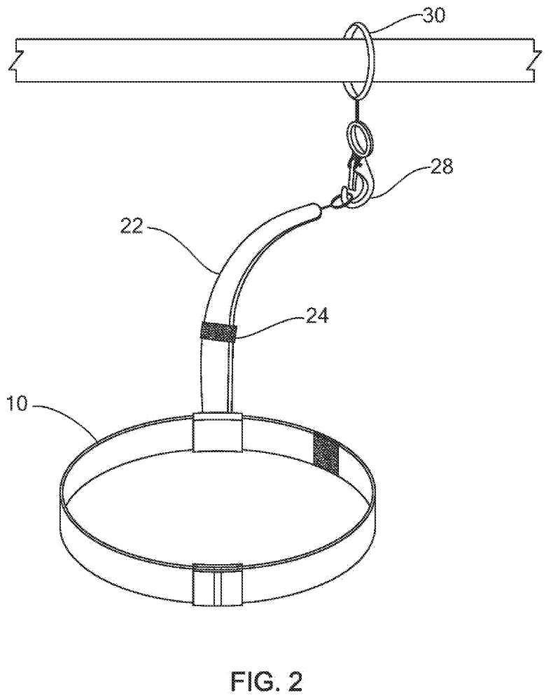

As shown in FIG. 2, in some embodiments, the attachment piece extending from the belt 10 may be an extension strap 22 fixed to or removably fixed to a portion of the belt 10. A size adjustment feature 24 may be provided to adjust the length of the extension strap 22. In some embodiments, a loop 26 may be disposed on the end of the extension strap 22. The loop 26 may permit the extension strap 22 to removably attach to a vehicle mounted hook 28. The vehicle mounted hook 28 may be disposed at one or more locations in the rescue vehicle to permit the user to attach their restraint belt. In some embodiments, the vehicle mounted hook 28 may be fixed to the vehicle or may slide along a rail in the vehicle. In some embodiments, the vehicle mounted hook 28 may be retractable extended from a vehicle lanyard 30 which may be designed similar to the lanyard 16 discussed above with respect to FIG. 1.

In some embodiments, at least a portion of the extension strap 22 may be elastic and permit extension thereof. Such an elastic line, similar to a bungee, may be useful to permit movement beyond a set length thereof. Further, such an elastic extension strap 22 can provide shock absorption should a rescue worker be restrained. The elastic extension strap can also help keep the extension strap 22 out of the way by permitting a shorter portion of the extension strap 22 to be used, where the user can stretch the extension strap 22 as needed to gain access within the vehicle, for example. Some or all of the extension strap 22 may be formed from an elastic material.

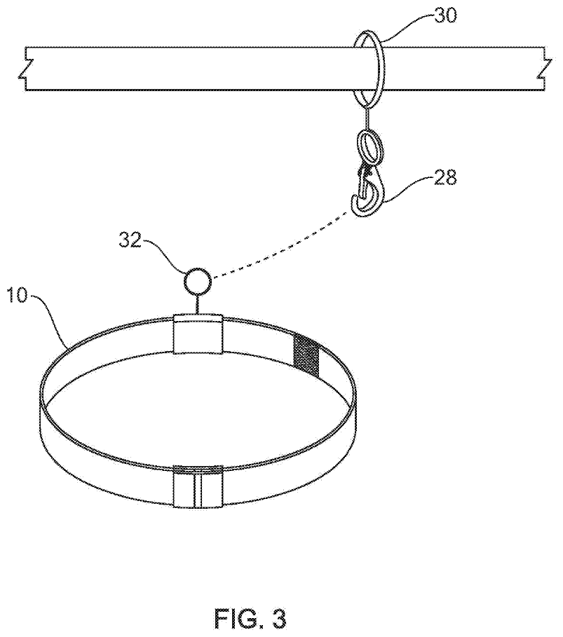

In some embodiments, as shown in FIG. 3, when a vehicle lanyard 30 is used, the extension strap 22 of FIG. 2 may be omitted and an eyelet 32 may be formed on the belt 10 so that the vehicle mounted hook 28 may be attached directly to the eyelet 32 of the belt 10.

As described above, the restraint belt 10 may be used in an emergency vehicle, such as an ambulance, fire truck or the like. The restraint belt 10 can restrain a user should the emergency vehicle be involved in an accident, keeping the rescue worker from being tossed around inside the vehicle or from being ejected from the vehicle. Often, such rescue workers cannot fasten seat belts, as they need to prepare on the way to a scene or take care of a patient that requires the user to stand or move about.

While the restraint belt 10 is shown as a strap that may be work along the waist or about the chest area of the user, in some embodiments, additional straps, such as shoulder straps (similar to suspenders) or leg straps may extend from the belt to better harness the wearer.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A rescue restraint comprising:
a belt configured to be worn about a user;
an extension piece extending from the belt, wherein at least a portion of the extension piece is formed from an elastic material;
a first connector disposed on an end of the extension piece; and
a second connector operable to be disposed in an emergency vehicle, the second connector mating with the first connector to secure the user within the emergency vehicle.

2. The rescue restraint of claim 1, further comprising one or more latches configured to open and close a loop formed by the belt.

3. The rescue restraint of claim 1, further comprising a size adjustment feature permitting a length of the belt to vary.

4. The rescue restraint of claim 1, wherein the extension piece is a line, the line extending from a lanyard attached to the belt.

5. The rescue restraint of claim 4, wherein the first connector is a hook disposed at the end of the line.

6. The rescue restraint of claim 1, wherein the extension piece is a strap extending generally orthogonally form the belt.

7. The rescue restraint of claim 6, wherein the first connector is an eye formed at an end of the strap.

8. The rescue restraint of claim 6, wherein the second connector is a vehicle hook operable to be secured inside the emergency vehicle.

9. The rescue restraint of claim 8, wherein the hook retractable extends from a vehicle lanyard operable to be secured inside the emergency vehicle.

10. A method of securing a person in an emergency vehicle, comprising:
positioning a belt about a user;
attaching a first connector at a distal end of an extension piece, extending from the belt, to a second connector disposed in the emergency vehicle.

11. The method of claim 10, further comprising opening a loop formed by the belt with one of one or more latches disposed along a length of the belt.

12. The method of claim 10, further comprising adjusting a size of the belt via a size adjustment feature disposed along a length of the belt.

13. The method of claim 10, further comprising extending the first connector from a lanyard, the lanyard permitting a predetermined length of line to extend therefrom, the first connector disposed on an end of the line.

14. The method of claim 10, further comprising restricting extending of the line from the lanyard when a velocity of the line exiting the lanyard exceeds a predetermined speed.

15. The method of claim 10, wherein the extension piece has a fixed length.

16. The method of claim 15, wherein an eye is disposed at the end of the extension piece.

17. The method of claim 16, wherein the second connector attaches to the eye.

18. The method of claim 17, wherein the second connector is extendably attached to a vehicle lanyard mounted in the emergency vehicle.

19. The method of claim 10, wherein the second connector is removably attached to a rail of the emergency vehicle.

20. The method of claim 10, further comprising dampening movement of the user by providing at least a portion of the extension piece as being a resilient elastic material.
